(19) United States
(12) Patent Application Publication
(10) Pub. No.: US 2005/0282126 A1
(43) Pub. Date: Dec. 22, 2005

(54) Self-coaching method and system

(76) Inventor: Tana Pesso, Brookline, MA (US)

Correspondence Address: TANA PESSO, 31 ELM ST., BROOKLINE, MA, 02445, US

(21) Appl. No.: 11/155,795

(22) Filed: Jun. 17, 2005

Related U.S. Application Data
(60) Provisional application No. 60/581,097, filed on Jun. 18, 2004.

(51) Int. Cl. G09B 19/00

(52) U.S. Cl. 434/236

(57) ABSTRACT

The present application is generally directed to a method and system for coaching individuals such as, e.g., employees of organizations such as large enterprises, to achieve predefined goals through the preferably daily practice or use of preferably a single habit, skill, action, or behavior. For example, the method and system can be used to keep an individual focused and disciplined over time to change behavior such as, e.g, acquiring or reinforcing a new skill or habit. The system is preferably delivered through an automated, web-based application using, e.g., expert systems to simulate a live coach's response to different performance scenarios. The self-coaching method and system can strengthen an individual's focus, discipline, and perseverance over time and thereby dramatically increase the likelihood of success of achieving a reliable new habit or mastering a new skill. Briefly, the self-coaching method and system guides users through the process of articulating self-improvement or other goals and then helps them attain their personalized goals. Users can submit self-monitoring records preferably twice daily through the web-based application. These records help individuals focus on and renew their commitment to their plan of action, reflect on their experiences, and assess their own efforts. The web tool can provide users with graphic representations of performance measures, which are preferably updated daily. The system can simulate using, e.g., expert systems, a real coach's response to the user's problems and progress during the course of the use of the system, which can be, e.g., 21 days.

### CROSS-REFERENCE TO RELATED APPLICATIONS

This application claims the benefit of provisional patent application Ser. No. 60/581,097, filed 2004 Jun. 18 by the present inventor.

### FEDERALLY SPONSORED RESEARCH

not applicable

### SEQUENCE LISTING OR PROGRAM

not applicable

### BACKGROUND OF THE INVENTION

1. Field of Invention

The present application is generally directed to a method and system for coaching individuals such as, e.g., employees of organizations such as large enterprises, to achieve predefined or self-determined behavior change goals through daily practice of preferably a single behavior. For example, the method and system can be used to keep an individual focused and disciplined over time to acquire or reinforce a new skill or to change behavior and habits. The system is preferably delivered through an automated, web-based application using, e.g., expert systems to simulate a live coach's response to different performance scenarios, or supplemented by utilizing a live coach.

2. Prior Art

With but a few quite primitive exceptions, none of the automated coaching, training, and behavior change programs approaches behavior change in the manner which this invention does. Thus, in a very real sense there is no prior art for this invention in the field of automated coaching and behavior change programs, methods, systems, and tools. Automated coaching and behavior change programs commonly rely on the following approaches to influence behavior change: objective performance measurement, insight, and/or education. By contrast, this invention does not incorporate or utilize any of the said common methods for coaching and influencing behavior change.

The four primary ways that other automated coaching and behavioral change programs attempt to bring about change through their program offerings are through:
Performance goals and measurement. The focus of programs utilizing this approach is on the end goal or outcome desired. An example of such a goal or outcome is the achievement of cost reductions in the manufacture of a company product. The assumption is that if people know they will be rewarded or punished according to their performance in achieving goals or outcomes, they will be motivated to make the required behavior changes necessary to achieve said goals. Another assumption of such programs is that initial goal articulation and subsequent measurement of performance and progress influence behavior change through enhancing visibility, a sense of accountability, and awareness. U.S. Pat. No. 2,005,058970 to Perlman (2005) relies primarily on goal setting and measurement as the means to promote behavior change.
Performance assessment and feedback tools. The focus of programs utilizing this approach is on the actual behavior needing change as opposed to the end goal or outcome which can be achieved by the behavior change. An example of a behavior which would be assessed and communicated through feedback tools to the user is delegation skills. The assumption underlying this approach to behavior change is that if people gain insight and understanding about deficiencies in the behaviors and skills which have been measured by the assessment tools, they will be motivated and enabled to effect a positive change in said behaviors and skills. U.S. Pat. No. 2,003,027116 to O'Donnell (2003) utilizes assessment and feedback tools as a primary vehicle for bringing about behavior change.
Planning, time management, and activity tracking tools. The focus of programs utilizing this approach is on the identification of tasks, steps, and plans to achieve end goals and outcomes. An example of this kind of program would be a project management plan and tracking tool. The assumption is that if all the steps required to achieve an end goal are made explicit with associated deadlines, plans, and schedules that people will follow the plan and achieve the desired outcome. In addition, it is assumed that tracking and reporting on progress sticking with the plan will influence behavior change by enhancing visibility, a sense of accountability, and awareness. U.S. Pat. No. 2,003,186202 to Isenberg (2002) relies primarily on planning and tracking tools as the means to influence behavior change.
Style, skill, and behavior change training and education. The focus of programs utilizing this approach is on providing people with information and content about what they need to do to effect behavior change and master new skills. These programs usually educate and inform people about a series of ideas or behaviors that people need to master, sometimes in a particular order. The assumption is that with knowledge about what to do people will implement the suggested changes in skills or habits during and after the training period. E.P patent 108485 to Healthlift LLC (2001) relies primarily on training and education to bring about behavior change.
   Below are some representative examples of prior art in the field of automated coaching and behavior change programs from industry leaders.
   Performance Goals and Measurement:
Cognos Metrics Manager improves your performance. Greater efficiency—align tactics with strategy to use resources effectively. Increased accountability—assign owners for each metric and responsibility for performance. Increased focus—concentrate on priorities and eliminate distractions. Improved communication—communicate results and actions taken to manage performance. Improved collaboration—use metrics to link together people, departments, and processes. (Cognos.com)
Halogen eAppraisal allows you to incorporate organizational goals at multiple levels and track relevant Milestones or Key Performance Indicators throughout the year. Supports “SMART” goals. Supports cascading goals. Lets you establish sophisticated scoring and weighting. Track goal and milestone/KPI status with drill down reports. Turn on or off ability to modify goals during review period (halogensoftware.com)
   Planning, Time Management, and Tracking:
MyHours.com is a time management, timesheet, time tracking solution. It enables you to track your work time, projects you work on and tasks you perform. It is web based and can be used from any location at any time. (myhours.com)
MyGoals.com walks you through a simple, step-by-step goal-setting process for any goal, whether it's short-term or long-term, easy or difficult, practical or lofty. We also provide pre-made GoalPlans® for popular goals, to get you started even faster. Once you've set a goal, we'll send you email reminders that arrive precisely when you should be working on each task. (mygoals.com)
   Assessment and Feedback:
Leadership Mirror: Multirater feedback surveys that provide insightful comparisons on how people see themselves relative to how others perceive them. And, Assessing Talent: People leader: DDI's Assessing Talent: People Leaders™—a web delivered behavioral assessment program—is an excellent tool for hiring and promotion decisions, and development of future and current leaders. (DDI.com)
360 Degree Feedback™: Right is a leader in the design and administration of 360 Degree Feedback™ systems for leadership development. 360 surveys give people feedback from their bosses, colleagues, and direct reports for a complete picture of their on-the-job effectiveness. Our 360 experts have been in the field for over two decades, providing the experience and advice our clients need to make such efforts successful. Right's individual assessments are research-based, user-friendly, and supported by comprehensive development and planning tools. (right.com)
   Education and Training:
Online Performance and Learning: OPALS provides day-to-day job performance and professional development learning via the user's personal computer for access anytime, anywhere. (ddi.com)
e-Learning gives you the power to move your business toward its goals, toward success and results. Harnessing the tremendous communication advantages of the web gives your training and development programs the power to captivate and motivate your workforce. You can have learning anytime, anywhere. And when that happens, you unleash the potential of your organization. (elementk.com)
   Live Coaching is Not Prior Art for this Invention.

Programs which rely on live coaches to provide support for behavioral change via any means and media are not considered to meet the definition for prior art in the field of automated coaching and behavior change programs. Specifically, online and web-based programs marketed as ecoaching tools whereby live coaches communicate with individual users via email or through live chat on websites are not considered to meet the definition for prior art in the field of automated coaching and behavior change programs.

Examples of such programs which rely on live coaches to provide support via email or live chat are: Nutricize.com; SouthBeachDiet.com; and MyCoach.com.

### BACKGROUND OF INVENTION—OBJECTS AND ADVANTAGES

Large organizations lose millions of dollars each year from lost productivity as a result of lack of follow through in the aftermath of workforce development training programs, performance reviews, and other forms of feedback. Corporations are estimated to spend $40 to $60 billion a year on training programs, roughly $750 per employee. According to a study conducted by The Xerox Corporation, 87% of the initial improvement in skills gained from training programs is lost when there is no follow-up. People generally return from training programs clear on what to do to improve their value at work, but often fail to implement their plans because it is difficult to sustain their focus on the new skills or habits for a long enough period to ensure their reliability. Likewise, after performance reviews, people are usually inspired to improve their work skills and habits, but often find it difficult to make a sustained effort to effect the changes they and their supervisors desire. Similar problems exist outside of the workplace, most notably with follow through on health management, fitness, sports, and self-help programs regardless of the media or means of presentation of such. Hence, a need exists for providing individuals both in the workplace and elsewhere with support and feedback to keep them on track and focused until new skills, habits, and attitudes become second nature. This invention meets that need in a totally unique manner.

This Invention Addresses The Key Flaw In All Prior Art. The key flaw in all prior automated coaching and behavior change programs is the assumption that people possess the focus, discipline, and perseverance to make desired changes in behavior. The assumption these programs are based upon is that either a) insight about what to do to improve or b) pressure to change will be sufficient to enable and motivate people to achieve a lasting improvement in their skills and habits. Insight is provided by these programs via training/education and/or via assessment/feedback Pressure to change is provided by performance measurement and tracking. However, studies indicate that people generally need a great deal of reinforcement and repetition to make changes “stick”. This invention addresses the key flaw of all other automated change programs by providing the means to strengthen people's focus, discipline, and perseverance over a time period that dramatically increases the likelihood of success in mastering new skills and establishing reliable new habits. In effect, the method and system of this invention provides users with an external support system that replicates the internal mindset of high achieving people.

Different Assumptions About Achieving Behavior Change Leads To Different Methods And Systems. Other behavioral change and coaching programs assume that individuals have the ability to persevere in mastering a skill or changing a habit until it is reliable and lasting. This invention is premised on the opposite assumption which is that most individuals do not have the ability to persevere without sufficient structure, guidance, and support. Hence this invention serves an entirely different purpose and utilizes entirely different means, methods, and systems than all other automated coaching and behavioral change programs.

This Invention Does Not Utilize The Three Categories Of Methods And Systems Commonly Used By Other Coaching And Behavior Change Programs. As stated in the preceding section on prior art, other programs included under the rubric of automated coaching and behavior change programs commonly rely on the following three approaches to influence behavior change: 1) objective performance measurement/tracking, 2) assessment/feedback, and/or 3) training/education. By contrast, this invention does not incorporate or utilize any of the said three common methods for coaching and influencing behavior change.
1. Objective Performance Measurement and Tracking. This invention does not provide the means, methods, or systems for objective performance measurement of users. (It does provide the means, methods, and systems for users to subjectively assess their own performance and progress in achieving their behavior change goals.)
2. Training and Education. This invention does not provide substantive content to educate or train users about what they ought to do or change in their behavior, habits, or skills.
3. Assessment and Feedback. This invention does not provide the means, methods, or systems to provide users with feedback and insight from third parties or through assessment tools about their behavior or performance. Below are a few examples of behavior change programs which rely on assessment and feedback:

Conversely, Other Coaching And Behavior Change Programs Do Not Utilize The Methods And Systems That Comprise This Invention. With but a few comparatively primitive exceptions, none of the other automated coaching and behavior change programs offers the means, method, and systems for the following key features of this invention:
1. Enabling the repetition of a preferably single skill or behavior over a period of time until the new habit or skill becomes reliable.
2. Simulating through expert systems a live coach's response to different performance scenarios based on user's self-assessments of two or more performance measures.
3. Guiding users to a) start the practice day by focusing, planning, and committing to their day's program and b) end the day by reflecting and assessing the day's performance.
4. Presenting users daily with one of three possible motivational statements which they personally have generated.

### SUMMARY

The present application is generally directed to a method and system for coaching individuals such as, e.g., employees of organizations such as large enterprises, to achieve predefined or self-determined goals through the preferably daily practice or use of preferably a single habit, skill, action, or behavior. For example, the method and system can be used to keep an individual focused and disciplined over time to change behavior such as, e.g, acquiring or reinforcing a new skill or habit. The system is preferably delivered through an automated, web-based application using, e.g., expert systems to simulate a live coach's response to different performance scenarios. The self-coaching method and system can strengthen an individual's focus, discipline, and perseverance over time and thereby dramatically increase the likelihood of success of achieving a reliable new habit or mastering a new skill. Briefly, the self-coaching method and system guides users through the process of articulating self-improvement or other goals and then helps them attain their personalized goals. Users can submit self-monitoring records preferably twice daily through the web-based application. These records help individuals focus on and renew their commitment to their plan of action, reflect on their experiences, and assess their own efforts. The web tool can provide users with graphic representations of performance measures, which are preferably updated daily. The system can simulate using, e.g., expert systems, a real coach's response to the user's problems and progress during the course of the use of the system, which can be, e.g., 21 days.

### DETAILED DESCRIPTION

The coaching system process is preferably implemented in a secure online application. The online application reduces the amount of time a user must spend at the beginning and end of each day the user uses the application, while increasing the benefits conferred through the process. The coaching system can use a variety of technology platforms including, e.g., Microsoft.NET. At the back-end, the system can use a server such as, e.g., Microsoft SQL Server.

Users can access the application in a general purpose computer. A representative computer is a personal computer or workstation platform that is, e.g., Intel Pentium®, PowerPC® or RISC based, and includes an operating system such as Windows®, OS/2®, Unix or the like. As is well known, such machines include a display interface (a graphical user interface or “GUI”) and associated input devices (e.g., a keyboard or mouse).

The coaching system can be implemented as a stand-alone, web-based application or as a combined application and coaching experience.

The coaching system program can be delivered to users through various possible modes. Corporate users, e.g., can access the coaching system through a preferably secure, web-based application hosted, e.g., on the company intranet and integrated with the company's branding, messaging, and training platform. The coaching system can also be made available to individuals and smaller corporate entities through a centralized, hosted public internet service designed for the mass market. In addition, the coaching system can be provided through recorded media such as, e.g., a CD-ROM for those with low bandwidth and other constraints. Judicious use of e-mail prompts and other reminders can optionally be used to draw users back into the program periodically. Live coaches can optionally supplement the online application when needed.

The coaching system is designed to help people maintain focus, discipline, and perseverance over a period of time to learn a new skill or to change an unwanted habit. The system is preferably used for a fixed period of time, e.g., 21 days. (While a 21-day program is generally described herein, it should be understood that the duration of the program can vary as needed.) The 21 days of the program may or may not be consecutive. In many cases, the 21 days will stretch over a period of 6 to 10 weeks. The program relies primarily on self-monitoring records submitted and reviewed through the coaching system web application. A morning or “A.M. Checkin” helps people focus on and renew their commitment to their plan of action. A later “P.M. Review” can be used for self-assessment of and reflection on the day's effort. Graphic and statistical representations of performance measures can be tracked and updated on a daily basis. Participants can preferably receive periodic “coach's messages” from the automated program in response to trends in their performance. These trends are filtered, e.g., through expert systems, which trigger responses intended to respond iteratively to performance data. These coach's messages, for instance, will encourage the user or seek to bring them back on track. The program can use expert systems or other mechanisms to mimic what a real (i.e., human) coach might say in response to certain trends in performance and responses. In a corporate version of the program, support and accountability for staying the course may be provided through periodic telephone coaching sessions with an outside live coach and a final review session with an immediate supervisor, peer, mentor, or someone on the HR staff upon completion of the program. Users working with the program on their own are encouraged to announce their goals at the outset of the program to a friend or some other person, and to meet with that person at a set date at the end of the program to review their experience.

Habits, Skills, and Behaviors

The coaching system is designed to help individuals—whether in a corporate or other setting or on their own—to make positive changes in their behavior. The expert systems-driven application in accordance with one or more embodiments is designed to enable improvement in various areas, including those described below. The coaching system can help keep people and organizations moving from insight and aspiration to change. The coaching system can help support people in making the changes they and their organizations have defined. These changes can include, but are not limited to the following:

Examples from a Corporate Setting

Follow-up on alcohol or drug treatment programs.
Make and follow-up on sales calls.
Take time for planning.
Handle high priority issues early in the day.
Do not let minor issues consume too much time.
Keep team values in the forefront of one's mind.
Delegate effectively.
Make steady progress toward business goals.
Take time for exercise or stress control practices.
Keep others in the loop (communication and coordination).
   Examples from a Personal Setting
Stick to an exercise regimen.
Stick to a diet regimen.
Stick to a medication regimen.
Take time for meditation or stress reduction.
Spend more time with friends and family.
Listen to one's children.
Control one's anger.
Manage personal finances better.
Plan for a new career.
Sleep better and longer.

The coaching system generally requires only a modest amount of time to use. The initial set-up of the program can, e.g., take between fifteen minutes and an hour, depending upon whether a coach is involved and other factors. From there on, the daily time commitment is modest, e.g., five minutes at the start of each day planning, and five minutes at the end of each day assessing, reflecting, and revising. The 21 days of the program refers to 21 days of practicing a single new action, behavior, or habit—and need not be 21 consecutive calendar days. In addition, the habit or skill is preferably practiced at least three times a week. The program duration can, e.g., be 21 days if the participant practiced the habit every single day. More typically, the program can take about ten weeks to complete.

The system preferably focuses on only one habit to change or skill to master during a given program. People tend to have difficulty sustaining focus and effort when the change goal that they have set for themselves is too complex. If there is more than one new habit in the works, they tend to slack off and give up. The coaching system is designed to increase the likelihood of success in creating a reliable new habit or mastering a new skill. Participants are accordingly preferably limited to using the process to create a single new habit or master a single new skill. The chances that they will successfully complete the program and succeed in achieving their goal are thereby improved.

A 21-day period generally means 21 days of practice, not necessarily 21 consecutive days. This element of the program is based on common sense, experience, and behavior modification research. It is generally not easy to learn new habits and to change old mindsets and attitudes. A few hours or even a few days in a training program, regardless of the quality of the material presented, is generally not sufficient to create real and lasting change in deeply rooted ways of behaving and interacting with others. It generally takes a persistent and consistent effort sustained over quite a long time to break old habits of thought and to create new ones which will stick. A good analogy is the time it takes to master a physical skill, such as tennis or playing a musical instrument, or to complete a course of physical therapy after an injury. One needs a sustained effort, preferably performed daily, over several months in order to achieve a sustainable level of skill or physical strength and stability. One wouldn't expect to become competent at playing the guitar after attending a single class or reading even the most thorough instruction manual. To learn a new skill or to create a new habit, be it physical or mental, one has to persevere steadily for a long enough time for it to become second nature. As a general rule, 21 work days of actual practice are necessary to ensure that people won't slip back into old habits.

Daily E-mail Prompts, Self-Monitoring Diaries, and the Interactive Program

In accordance with one or more embodiments of the invention, the use of a daily self-monitoring diaries combined with an interactive daily email program helps people to sustain the self-discipline and self-awareness necessary to complete a long-term program of change. A recent study out of Brown University found that people engaged in a weight loss program who kept self-monitoring diaries and received short weekly email feedback based on their diary submissions lost three times as much weight as people who followed the same program, but did not keep the self-monitoring diaries or receive email coaching. The email prompts serve as a daily reminder to stick with the program. Users can choose from a variety of personalized means of notification including email, NET alerts, a tickler bar, an application that runs on the taskbar and gently pulses a color to indicate your status, automatic wake up calls (electronic voice), faxes, and other means.

Self-Assessment Ratings of Effort and Habit Reliability

There is a great deal of social science literature attesting to the power of using performance measures to bring about organizational and individual change. Since there is no feasible way to institute an objective means of performance measurement for program participants, the best available alternative is to utilize self-assessment. It has been found that users who have tested the coaching system application take these ratings very seriously and are highly motivated to improve their performance as a result. The use of the ratings forces participants to take an honest look at their commitment to the program and makes it more difficult to turn a blind eye when they start to slack off.

Reflection Record

In accordance with one or more embodiments, a reflection record is kept by users. The reflection record can be a journal or diary feature. There has been quite a bit of research support in the behavior modification arena that journal keeping is an effective tool for bringing about behavior change. Reflection aids in problem solving insofar as people will reflect on what helps and what hinders their efforts, and therefore adjust their plans and actions accordingly.

Change Goal Statement

The coaching system in accordance with one or more embodiments helps users to identify and enunciate the new habit or skill they wish to change or improve.

Outcomes Statement

Personal. In accordance with one or more embodiments of the invention, users enunciate the goal or outcome they hope to achieve as a way to motivate themselves to keep up a sustained effort. A well-known study of Harvard graduates showed a strong correlation between high achievement and clear goal articulation. Work Group and Organization. In accordance with one or more embodiments of the invention, in the context of an organization, users consider not only the personal outcomes they hope to achieve, but also the likely outcomes for their work group and the organization as a whole. People's sense of motivation tends to increase when they feel a commitment to achieve results for more than their own personal reward. The articulation of the positive results of their program for their work group and organization should up the ante as it were in terms of motivation and commitment to staying the course and putting in the best effort.

Cost of Failure Statement

In accordance with one or more embodiments users to take a good hard look at and enunciate the problems they will continue to experience if they do not succeed in making the changes they have committed to make.

Tactics Statement.

In accordance with one or more embodiments, the coaching system helps users identify likely obstacles and create tactics for overcoming them. The coaching system can enable participants to anticipate the range of obstacles that might arise in the pursuit of a change goal and to think about ways they will overcome those obstacles. Being realistic and prepared in this way greatly increase their chances of ultimately succeeding in creating reliable good new habits or breaking old bad ones.

Program Set-Up

The program set-up in accordance with one or more embodiments is now described. The user initially creates the four statements. These are the Change Goal, Outcomes, Cost of Failure, and Tactics Statements. Upon enrolling in the program, participants will be led through a series of questions that will lead to create these four key statements. Users will have the opportunity every day to revise the statements as necessary. They will also be asked to announce the periodicity of their participation. In other words, do they expect to participate every day, every work day, every other day, or three times a week. They may also indicate their preference for receiving email prompts or initiating their programs on their own without prompts. Once the set-up is complete, people are ready to begin their 21-day program at any time.

Visualization

The coaching system in accordance with one or more embodiments can direct users to visualize themselves enacting various actions and experiencing various future scenarios. Participants are likely to choose to develop new habits (or break old ones) that have eluded them for years. Visualization can increase the likelihood of success in bringing about the changes they want. Visualization can be a first step towards taking real action. Visualization has in the past been used with success extensively in training competitive athletes and in behavior modification programs.

Daily Participation Requirements

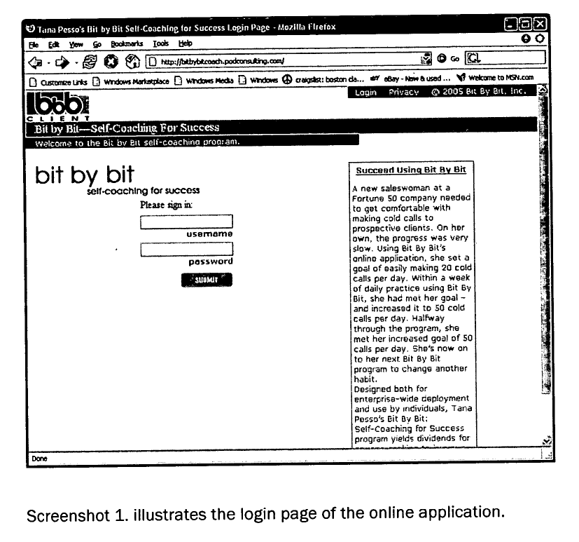

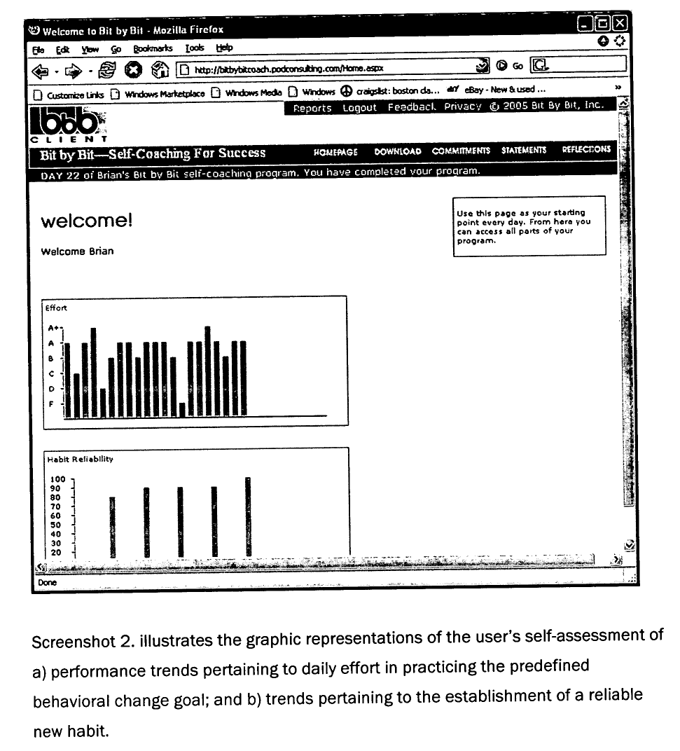

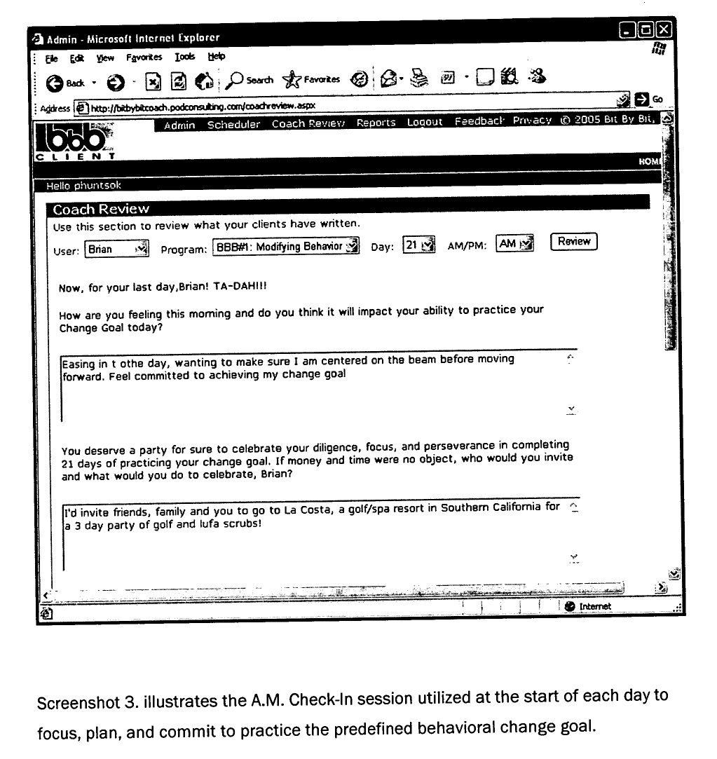

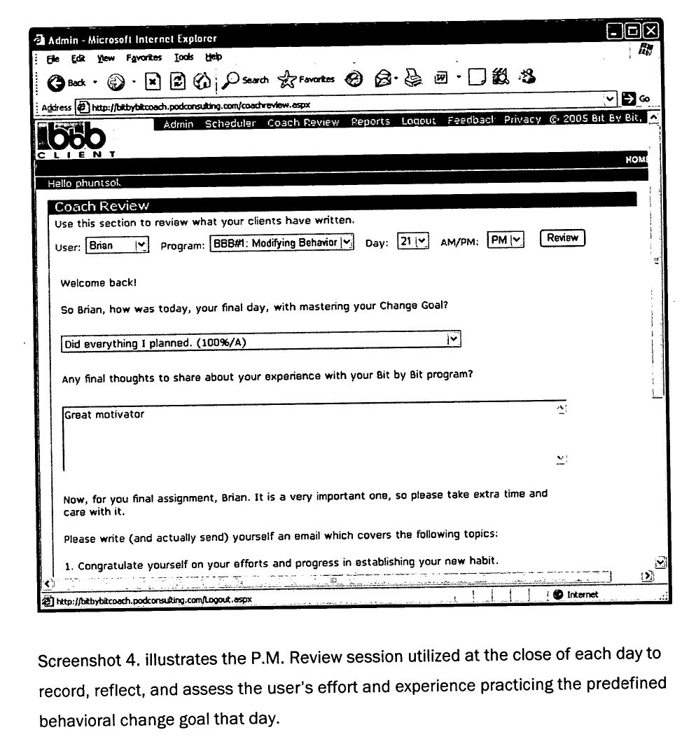

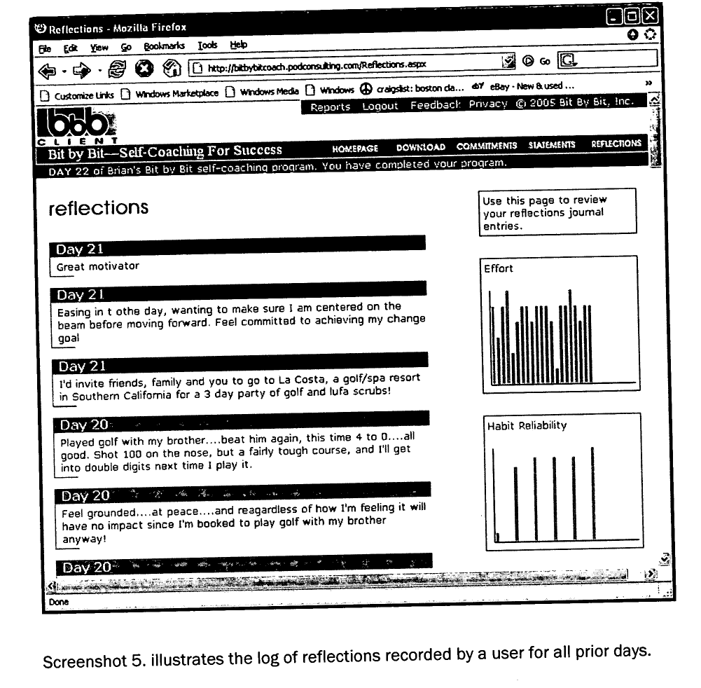

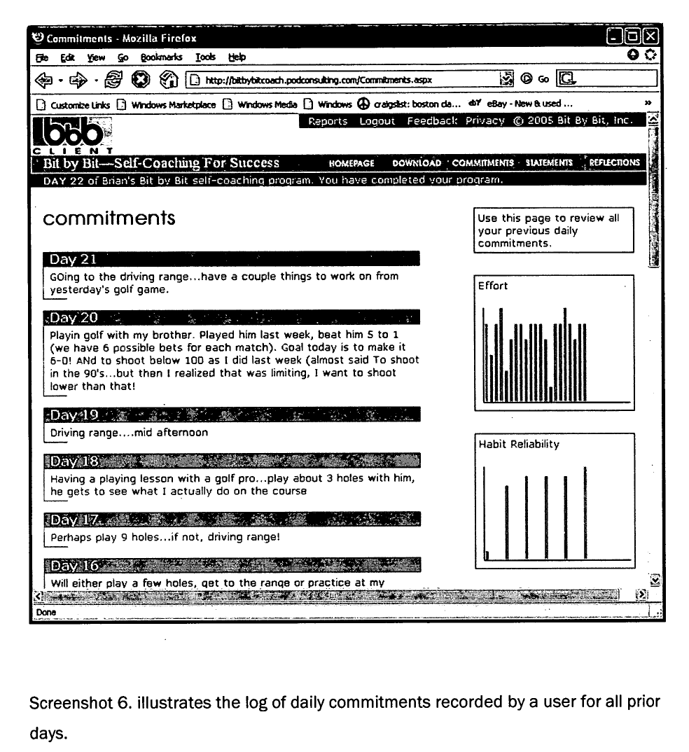

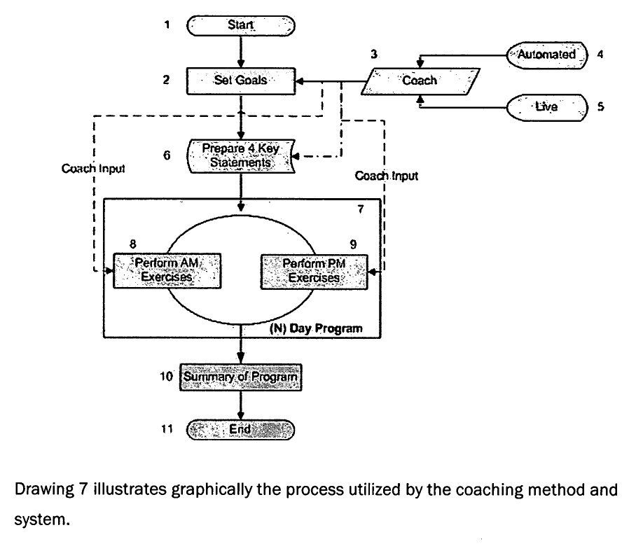

Participants interact with the coaching system preferably two times every day. At the start of their day they complete the A.M. check-in form. This form allows users to review their four statements using visualizations where appropriate, write a statement regarding their action commitment for the day, and engage in other exercises designed to facilitate focus, planning, and commitment. FIG. 3 is an example of a screen shot of an A.M. check-in form.

At the end of the day, participants complete the P.M. review form, which allows them to rate their effort in practicing their new habit and assess the reliability of the habit thus far. It also provides them with an opportunity to revise their four statements and to reflect on their experience in practicing their new habit, action, or behavior. Participants can check logs containing the record of all prior reflections, coach's messages, earlier versions of statements, and daily action commitments at any time.

Program Elements

The program elements that a participant generally uses on a daily basis are:
Change Goal Statement. The Change Goal Statement is a description of the action, behavior, mental attitude, habit, or skill that the participant has chosen to practice in the coaching system program. There may be a set of related or auxiliary actions, etc. that can also be included here and can be practiced on the days when the primary action cannot be practiced for whatever reason. The action statement identifies a single action or related set of actions to be practiced in the same way repeatedly day after day for a total of 21 days. The participant will be instructed to avoid setting up a series of phased actions or tasks as one would use in any planning program. He or she will also be instructed to make the distinction between the end goal one hopes to achieve through the actions and the action itself. The Change Goal Statement only addresses the behavior that is to be practiced daily, not the outcome, goal, or result of that behavior.
Outcomes Statement. Users define the outcomes, goals, and results they hope will come about as a result of their mastery of the new habits they have established by completing their program. They are prompted to identify preferably both short-term and long-term goals. Corporate users or users associated with other organizations may be prompted to identify personal, group, and corporate or organization goals they hope will be furthered through their mastery of the new habit or skill they have chosen to address.
Cost of Failure Statement. The Cost of Failure Statement is the flipside of the Goal Statement. It identifies all the problems that will occur and opportunities that will be lost if the participant fails to master the skill, action, behavior, or habit they have chosen to address in their coaching system program.
Tactics Statement. Users can list all the obstacles and roadblocks that are likely to arise making it difficult for them to practice their Change Goal behavior during the course of the coaching system program. They are then prompted to think of tactics to overcome such obstacles when and if they occur. The program can offer suggestions for overcoming standard obstacles for different kinds of behavior change goals. It can also recommend that users ask their friends and colleagues or others for help in developing effective strategies for overcoming those obstacles which stump them.
Self-Rating of Effort and Habit Reliability. At the end of each day participants are prompted on the P.M. review form to rate themselves on their level of effort that day in practicing their new habit. At the every fourth day users are prompted on the PM review form to rate themselves on the extent to which the new habit has become reliable and stable. These ratings can be shown in graphically and may be displayed on every page of the program.
Reflections. The P.M. review form gives participants the opportunity to record their reflections on their experiences during the day as they tried to practice their target behavior, skill, habit, or mental attitude. The program will offer guidelines as to aspects of the experience upon which one might usefully reflect.
Coach's Messages. The coaching system program can generate messages from the “coach” periodically in response to certain patterns of performance and input by participants. The message generation is preferably automated. In the corporate version some of these messages may be from an actual coach assigned to the participants. If the participant seems to be having difficulty sticking with their program, the coach's message may also be sent by email.
Logs. Participants can access, but preferably not alter, logs of all previous records listed in chronological order including but not limited to the following items: revised statements; reflections, daily action commitments, and coach's messages.
Revision Opportunity. Participants are given the opportunity to revise any of the four statements during the course of the program on designated days as well as through a revise function which can be accessed and utilized by the participant at any point in the program. Any changes made are reflected in the next day's version of the statements in both the A.M. and P.M. forms. The prior versions of the newly revised statement are recorded in the revised statements log in chronological order.

### EXAMPLES

The following are examples illustrating various types of statements and reflections made by individuals during use of the coaching system.

### Example One

### A Salesperson Who Needed to Increase Her Daily Quota of Cold Calls

Change Goal Statement: Make a minimum of 50 cold calls a day. Do two sessions of letter writing to prospective clients a week. Spend one day a week networking.

Outcomes Statement: Have two more submissions and have written at least one case of reasonable size, or two small cases by the end of January. Make one good account sale by June. Develop the ability to pitch and represent my own start up company. Pay off my debts.

Cost of Failure Statement: Won't have prospects and without them will be dead in the water. Spin wheels if don't find the right market. Can't pay debts. Lose job and salary. Lose face.

Tactics Statement:

Problem: Get distracted, lazy, moody, or ambivalent

Tactics: Use time management to set priorities. Remind self of what might lose if I don't get going, money and face. Think about the competition. What if young college grads outperform me? Motivate self by thinking about the great job I can get next time with this experience.

Problem: Returningjunk emails until late afternoon.

Tactics: Do cold calls first thing in the morning. Work at home, wake up, have coffee, meditate, then call.

Problem: Stressed out and don't feel jazzed up.

Tactics: Drink less at night. Work out at the gym more.

Reflection Log Entry: Today was a better day for making cold calls than I've had in a long time, as I was forced to focus regardless of the anxiety about making cold calls. I just went ahead despite my feelings and made the calls. I also looked into a new call list and tried to fellow up on a lead. And, I set up a networking event schedule for the next two weeks. The flow of work was much better. However, I discovered that I still do not have perfect calling list, and need to target warm markets more.

### Example Two

### A Golfer Wishing to Play Consistently at His Best Level

Change Goal Statement: Practice a quality swing every day likely in the evening for fifteen or twenty minutes. Also get to the driving range twice a week. Weekly review the chapter on the swing in Jim Linkins book. Play once a week.

Outcomes Statement: Hit the ball squarely straighter less mistakes take ten strokes off my average score of one hundred. Consistently beat my brother. Feel pretty good. Enjoy the game even more. Push myself over the edge of the plateau I've been on. Long term might shoot in mid-eighties or hi-seventies if I show to myself that I can produce a better swing.

Cost of Failure Statement: Frustrating because there are times when I hit the ball exceptionally well and not by accident but loads of time when I don't hit well. I should be able to be better. Frustrating not to have made the step of steady change. My brother will continue to have an edge on me.

Tactics Statement:

Problem. The kids need my time.

Tactics. Tell them that I've got this goal. Need to take some time enlist their support or at least their awareness.

Reflection Log Entry:

Played an actual golf match with my brother and two friends. Not just playing a round where nothing counted (other than wanting to go well) . . . this was for bragging rights! Thinking about problems I have run into . . . weather didn't help me as far as practicing one day (I have room at home, but not at the apartment). Beyond that, I can also call upon the trigger more often when getting ready for shots. I don't use it every time, but might not be a bad idea. Anyway, I think just by taking a moment before each shot to have a quick flash, and to commit myself to that before the start of a round would be helpful.

### Example Three

### An Aggressive Young Salesman Who Tended to Overpower Others with a Fast, Loud Pattern of Speech

Change Goal Statement: When I feel pressured or insecure I will slow down my speech so I can listen to myself talk as well as hear others better.

Outcomes Statement: Be able to communicate effectively to achieve definite results in both business and personal life gracefully and while leaving a lasting good impression with the people I am communicating with. Establish an image of being graceful communicator with poise regardless of results.

Cost of Failure Statement: People will have an impression of me as someone who is nervous, young, and restless and therefore not professional. They will seem me as lacking self-confidence. People will feel pressured by me and react negatively rather than positively. In sales, professional image is 80 percent of the game, so the cost of damaging that image is tremendous.

Tactics Statement:

Problem: To feel rushed by the emotion and mouth just opens.

Tactics: Feel the emotion without acting on it. Take a deep breath and let the emotion dissolve on the spot before words come out of my mouth. Fake a smile, then speak.

Reflection Log Entry:

This isn't easy to do. It seems a little forced when I stop and slow down my speech, but no one commented on it today, so I guess it doesn't seem to strange to others and I'll probably get used to it myself in time.

Software Implementation

The coaching system is preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

### CONCLUSION, RAMIFICATIONS, AND SCOPE

Having described preferred embodiments of the present invention, it should be apparent that modifications can be made without departing from the spirit and scope of the invention.

1. A method and system of coaching individuals to achieve predefined or self-determined goals by practicing preferably a single behavior preferably daily during the course of the use of the said method and system, and preferably delivered through an automated web-based application using, e.g., expert systems to simulate a live coach's responses to patterns in performance scenarios:

1. A method and system of guiding users through the articulation of i) goals, preferably a single behavior, habit, skill, or action, ii) motivational factors, and iii) tactical plans preferably delivered through an automated web-based application or a computer program on a CD-ROM, USB stick, or other media;

2. a method and system of guiding users through the articulation of predefined, e.g., organizational, goals, motivational factors, and tactical plans;

3. a method and system of guiding users through the articulation of personalized self-improvement goals, motivational factors, and tactical plans;

4. a method and system of guiding users through the articulation of a mix of predefined organizational and personalized self-improvement goals, motivational factors, and tactical plans;

5. A method and system guiding users to practice or repeat preferably daily a preferably single behavior, habit, skill, or action during the course of the use of the system, which can be, e.g., 21 days, preferably delivered through an automated web-based application or a computer program on a CD-ROM, USB stick, or other media.

6. a method and system guiding users to submit self-monitoring records preferably twice daily;

7. a method and system guiding users to submit self-monitoring records whereby the initial submission consists of plans and goals articulated for that day;

8. a method and system guiding users to submit self-monitoring records whereby the latter submission guides users to reflect on, evaluate and capture their assessment with regard to the above (3a);

9. a method and system to ensure confidentiality of user submissions.

10. a method and system of providing graphic representations and reports of user performance measures, which are preferably updated daily;

11. a method and system of providing graphic representations and reports of user compliance, which are preferably updated daily;

12. a method and system of providing graphic representations and reports of user self-assessment ratings, which are preferably updated daily.

13. A method and system of providing automated replicated coach's responses to trends and patterns in an individual user's performance scenarios as indicated by program users, or utilizing a live coach preferably delivered through an automated web-based application or a computer program on a CD-ROM, USB stick, or other media.
whereby said method or system helps program users keep focused, disciplined, and motivated to persevere over the period of time required to change behavior, acquire a new skill, and/or develop a reliable new habit.
